(19) United States
(12) Patent Application Publication
(10) Pub. No.: US 2018/0203282 A1
(43) Pub. Date: Jul. 19, 2018

(54) METHOD FOR ENHANCING THE STRENGTH OF LIQUID CRYSTAL CURVED-SURFACE PANEL

(71) Applicant: Shenzhen China Star Optoelectronics Technology Co. Ltd., Shenzhen (CN)

(72) Inventor: Jiaxin LI, Shenzhen (CN)

(21) Appl. No.: 15/513,558

(22) PCT Filed: Feb. 13, 2017
(86) PCT No.: PCT/CN2017/073339

§ 371 Date: Mar. 23, 2017

(30) Foreign Application Priority Data
Jan. 18, 2017 (CN) 201710033768.2

(51) Int. Cl. G02F 1/1333; C03C 15/02; C03C 17/06; C03C 17/32

(52) U.S. Cl. CPC G02F 1/133305; C03C 15/02; C03C 17/06; C03C 2217/70; G02F 2201/501; G02F 2201/56; C03C 17/32

(57) ABSTRACT

A method for enhancing a strength of a liquid crystal curved-surface panel is provided, which includes determining a tensile stress area where the liquid crystal curved-surface panel undergoes a maximum tensile stress; calculating a length and a width of the tensile stress area; removing microcracks on the tensile stress area; and coating a water vapor proof layer on the tensile stress area and a peripheral area around it, the water vapor proof layer preventing an invasion of water vapor. The method can greatly increase the strength of the liquid crystal curved-surface panel, thereby greatly reducing the risk of fracture.

### TECHNICAL FIELD OF THE DISCLOSURE

The present invention relates to a liquid crystal display technology, and more particularly, to a method for enhancing the strength of a liquid crystal curved-surface panel.

### BACKGROUND OF THE DISCLOSURE

With the increasing curvature of curved televisions, the failure of glass substrates under long-term bending stress becomes a problem that needs to be evaluated. Although there are few examples of glass substrate breakage immediately after assembly, sudden fracture of curved liquid crystal panels often occurs after assembly of the curved televisions has been completed a few months ago. This is caused by the fatigue of the material. Since the strength of the glass substrates is mainly determined by microcracks on the end face of the glass substrates, the microcracks continue to grow under the tensile stress caused by the long-term bending, then create instability, and eventually cause fracture of the glass substrates due to stress erosion. In the process of fracture, the microcracks at the terminal of the curved liquid crystal panel are the most important factors causing the fracture. Stress erosion plays a major role in the chemical mechanism, in which water vapor has an important role. Water vapor will erode the Si—O bond in the glass substrates.

The strength of the glass substrates is generally enhanced by chemical means, that is, fabricating a compressive stress layer on the surface of the glass substrates using an ion exchange approach. Corning's phone cover glass is a typical example. However, the curved liquid crystal panels are manufactured from alkali-free glass, which cannot use such an approach. Another way is required. This problem needs to be solved.

### SUMMARY OF THE DISCLOSURE

The objective of the present disclosure is to provide a method for enhancing the strength of a liquid crystal curved-surface panel for solving the problem in existing skills that the liquid crystal curved-surface panel is susceptible to water vapor erosion in the area where the tensile stress is greatest, leading to the growth of microcracks on it, which eventually causes the liquid crystal curved-surface panel to fracture.

The technical schemes provided in the present disclosure are described below.

A method for enhancing a strength of a liquid crystal curved-surface panel, comprising the steps of: 1) determining a tensile stress area where the liquid crystal curved-surface panel undergoes a maximum tensile stress; 2) calculating a length and a width of the tensile stress area; and 3) coating a water vapor proof layer on the tensile stress area and a peripheral area around the tensile stress area, the water vapor proof layer preventing an invasion of water vapor.

Preferably, a volume of the water vapor proof layer coated on the peripheral area around the tensile stress area is determined according the length and the width of the tensile stress area.

Preferably, before the step of coating the water vapor proof layer on the tensile stress area and the peripheral area around the tensile stress area, the method further comprises a step of: removing microcracks on the tensile stress area so as to coat the water vapor proof layer on the tensile stress area.

Preferably, an erosion material able to erode the liquid crystal curved-surface panel is used to remove the microcracks on the tensile stress area.

Preferably, the erosion material is hydrofluoric acid and a volume of the hydrofluoric acid is determined according to a depth of the microcracks.

Preferably, the method further comprises coating the water vapor proof layer at upper and lower chamfers of the liquid crystal curved-surface panel corresponding to the tensile stress area in addition to coating the water vapor proof layer on the tensile stress area and the peripheral area around the tensile stress area.

Preferably, a material of the water vapor proof layer is epoxy resin or metal powders.

Preferably, the tensile stress area of the liquid crystal curved-surface panel subjected to the maximum tensile stress is determined by a computer simulation model.

Preferably, the liquid crystal curved-surface panel comprises an array substrate and a color film substrate facing each other, wherein the array substrate is subjected to a tensile stress, and the color film substrate is subjected to a compressive stress, and the tensile stress area is located on the array substrate.

Preferably, the liquid crystal curved-surface panel is an organic glass panel, and the tensile stress area is located at a curved region having a largest curvature of the array substrate.

A method for enhancing a strength of a liquid crystal curved-surface panel, comprising the steps of: 1) determining a tensile stress area where the liquid crystal curved-surface panel undergoes a maximum tensile stress; 2) calculating a length and a width of the tensile stress area; 3) removing microcracks on the tensile stress area so as to coat a water vapor proof layer on the tensile stress area; and 4) coating a water vapor proof layer on the tensile stress area and a peripheral area around the tensile stress area, the water vapor proof layer preventing an invasion of water vapor, wherein a volume of the water vapor proof layer coated on the peripheral area around the tensile stress area is determined according the length and the width of the tensile stress area.

Preferably, an erosion material able to erode the liquid crystal curved-surface panel is used to remove the microcracks on the tensile stress area.

Preferably, the erosion material is hydrofluoric acid and a volume of the hydrofluoric acid is determined according to a depth of the microcracks.

Preferably, the method further comprises coating the water vapor proof layer at upper and lower chamfers of the liquid crystal curved-surface panel corresponding to the tensile stress area in addition to coating the water vapor proof layer on the tensile stress area and the peripheral area around the tensile stress area.

Preferably, a material of the water vapor proof layer is epoxy resin or metal powders.

Preferably, the tensile stress area of the liquid crystal curved-surface panel subjected to the maximum tensile stress is determined by a computer simulation model.

Preferably, the liquid crystal curved-surface panel comprises an array substrate and a color film substrate facing each other, wherein the array substrate is subjected to a tensile stress, and the color film substrate is subjected to a compressive stress, and the tensile stress area is located on the array substrate.

Preferably, the liquid crystal curved-surface panel is an organic glass panel, and the tensile stress area is located at a curved region having a largest curvature of the array substrate.

The beneficial effects of the present disclosure are described below. In the present disclosure, the method for enhancing the strength of a liquid crystal curved-surface panel can greatly increase the strength of the liquid crystal curved-surface panel by coating the water vapor proof layer on the tensile stress area and its peripheral area, thereby greatly reducing the risk of fracture.

### BRIEF DESCRIPTION OF THE DRAWINGS

FIG. 1 is a flow chart of a method for enhancing the strength of a liquid crystal curved-surface panel in accordance with an embodiment of the present disclosure.

### DETAILED DESCRIPTION OF THE DISCLOSURE

The following descriptions for the respective embodiments are specific embodiments capable of being implemented for illustrations of the present disclosure with referring to appending figures. In descripting the present disclosure, spatially relative terms such as “upper”, “lower”, “front”, “back”, “left”, “right”, “inner”, “outer”, “lateral”, and the like, may be used herein for ease of description as illustrated in the figures. Therefore, the spatially relative terms used herein are intended to illustrate the present disclosure for ease of understanding, but are not intended to limit the present disclosure. In the drawings, units having similar structures are labeled by the same reference numbers.

### Embodiment I

The liquid crystal display panel includes acrylic glass, which is high in light transmittance and can transmits up to 92%, and is lightweight and not fragile, widely applied in a panel or baffle of a machine. The glass substrate is sensitive to tensile stress, and is easily to be fractured by bending and pulling stress, and temperature stress. The stress inducing the damage is failure strength of the glass. Theoretically, the glass substrate has an extremely high failure strength, and it requires a stress up to 10 GPa to cut off the Si—O bond. In fact, the strength of the glass substrate is only 1% of the theoretical value or lower because of microcracks on the surface of the glass substrate. There is a large quantity of micrometer cracks on the surface of the glass substrate, and they rapidly grow under tensile stress. A stress concentration area obviously appears on a tip of the microcrack. This is why the strength of the glass substrate is far below the theoretical value. In addition, a hot and humid environment can exacerbate the problem, and therefore a water vapor proof process needs to be exerted on the glass substrate.

The liquid crystal display panel is manufactured using acrylic glass. Ordinary chemical approaches (that is, fabricating a compressive stress layer on the surface of the glass substrate using an ion exchange approach) adopted for increasing strength of the glass substrate are not work herein. Therefore, the present disclosure providing the following technical schemes in order to increase strength of a liquid crystal curved-surface display panel.

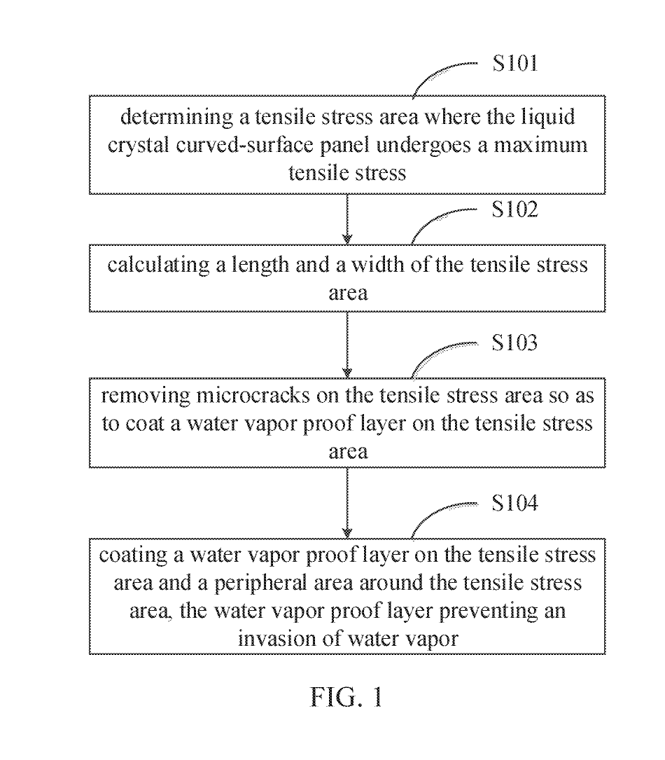

FIG. 1 is a flow chart of a method for enhancing the strength of a liquid crystal curved-surface panel in accordance with the present embodiment. As can be seen from FIG. 1, the strength enhancing method of the present disclosure includes the followings steps:

Step S101: determining a tensile stress area where the liquid crystal curved-surface panel undergoes a maximum tensile stress.

Step S102: calculating a length and a width of the tensile stress area.

Step S103: removing microcracks on the tensile stress area so as to coat a water vapor proof layer on the tensile stress area.

Step S104: coating the water vapor proof layer on the tensile stress area and a peripheral area around the tensile stress area, the water vapor proof layer preventing an invasion of water vapor.

In the present embodiment, the volume of the water vapor proof layer coated on the peripheral area around the tensile stress area is determined according the length and the width of the tensile stress area. This involves a limit problem. Based on the experience, the peripheral area surrounding the tensile stress area has to be considered. It is required to coat the water vapor proof layer on the peripheral area around the tensile stress area so as to prevent the peripheral area from cracking.

In the present embodiment, an erosion material able to erode the liquid crystal curved-surface panel can be used to remove the microcracks on the tensile stress area. The erosion material can erode the microcracks such that a portion is removed from the tensile stress area, which then becomes concave. In this way, it is convenient to coat the water vapor proof layer.

In the present embodiment, the erosion material is hydrofluoric acid (HF) and the volume of the hydrofluoric acid is determined according to the depth of the microcracks. This is processed according to the experience, and the experience shows that the microcracks of a certain depth or thickness are eroded by a certain quantity of hydrofluoric acid.

Hydrofluoric acid has an ability to dissolve oxides. It plays an important role in the purification of aluminum and uranium. Hydrofluoric acid can also be used to etch glass, form a pattern by carving, and mark with a scale and a text. It is used in the semiconductor industry in removing oxides on silicon surfaces. In an oil refinery, it acts as a catalyst in an alkylation reaction of isobutane and α-butylene. It is also used as a pickling agent to remove oxides and other impurities from stainless. Many organofluorine compounds are prepared using hydrofluoric acid, including Teflon, and refrigerants such as Freon.

In the present embodiment, in addition to coating the water vapor proof layer on the tensile stress area and the peripheral area around it, the method further includes coating the water vapor proof layer at upper and lower chamfers of the liquid crystal curved-surface panel corresponding to the tensile stress area. The upper and lower chamfers of the liquid crystal curved-surface panel corresponding to the tensile stress area undergo a large tensile stress and are thus easily to be cracked.

In the preset embodiment, the material of the water vapor proof layer is epoxy resin or metal powders. Epoxy resin generally refers to an organic compound, of which molecules contains two or more than two epoxy groups. With few exceptions, their molecular weights are not high. The molecular structure of the epoxy resin is characterized by the presence of a reactive epoxy group in the molecular chain, and the epoxy group may be at the terminal, intermediate of the molecular chain, or a cyclic structure. The molecular structure contains lively epoxy groups, so that they can cross-react with a variety of types of curing agents to form an insoluble polymer with a three-way network structure. Polymer compounds having a molecular structure containing epoxy groups are referred to as epoxy resin. Cured the epoxy resin has good physical and chemical properties. It has excellent bonding strength to the surfaces of metal and nonmetallic materials, good dielectric properties, small deformation shrinkage, good dimensional stability, high hardness and flexibility, and high stability for alkali and most of the solvents, and thus is widely used in national defense, national economy departments, and is used for casting, dipping, laminating materials, adhesives, and coatings.

Metal powders are a loose material. Their performance reflects the nature of the metal itself and the properties of individual particles and particle groups. Generally, the performance of metal powders is divided into chemical properties, physical properties and technical properties. Chemical properties refer to metal content and impurity content. Physical properties include the average particle size and particle size distribution of the powders, the specific surface and true density of the powders, the shape of the particles, the surface morphology and the internal microstructures. Technical properties are a comprehensive performance, including powder flow, bulk density, tap density, compressibility, formability and sintering size changes. In addition, some special applications also require the powders with other chemical and physical properties, such as catalytic performance, electrochemical activity, erosion resistance, electromagnetic properties, and internal friction coefficient.

In the present embodiment, the tensile stress area of the liquid crystal curved-surface panel subjected to the maximum tensile stress is determined by a computer simulation model. The steps are to first create a model on the computer, then divide it into grids (discretization), and finally calculate the tensile stress area by applying forced displacements according to the curvature of the design.

In the present embodiment, the liquid crystal curved-surface panel includes an array substrate and a color film substrate facing each other, wherein the array substrate is subjected to a tensile stress, and the color film substrate is subjected to a compressive stress, and the tensile stress area is located on the array substrate.

In the present embodiment, the liquid crystal curved-surface panel is an organic glass panel, and the tensile stress area is located at a curved region having the largest curvature of the array substrate.

In the present disclosure, the method for enhancing the strength of a liquid crystal curved-surface panel can greatly increase the strength of the liquid crystal curved-surface panel by coating the water vapor proof layer on the tensile stress area and its peripheral area, thereby greatly reducing the risk of fracture.

While the preferred embodiments of the present disclosure have been illustrated and described in detail, various modifications and alterations can be made by persons skilled in this art. The embodiment of the present disclosure is therefore described in an illustrative but not restrictive sense. It is intended that the present disclosure should not be limited to the particular forms as illustrated, and that all modifications and alterations which maintain the spirit and realm of the present disclosure are within the scope as defined in the appended claims.

What is claimed is:

1. A method for enhancing a strength of a liquid crystal curved-surface panel, comprising the steps of:
1) determining a tensile stress area where the liquid crystal curved-surface panel undergoes a maximum tensile stress;
2) calculating a length and a width of the tensile stress area; and
3) coating a water vapor proof layer on the tensile stress area and a peripheral area around the tensile stress area, the water vapor proof layer preventing an invasion of water vapor.

2. The method according to claim 1, wherein a volume of the water vapor proof layer coated on the peripheral area around the tensile stress area is determined according the length and the width of the tensile stress area.

3. The method according to claim 1, before the step of coating the water vapor proof layer on the tensile stress area and the peripheral area around the tensile stress area, further comprising a step of:
removing microcracks on the tensile stress area so as to coat the water vapor proof layer on the tensile stress area.

4. The method according to claim 3, wherein an erosion material able to erode the liquid crystal curved-surface panel is used to remove the microcracks on the tensile stress area.

5. The method according to claim 4, wherein the erosion material is hydrofluoric acid and a volume of the hydrofluoric acid is determined according to a depth of the microcracks.

6. The method according to claim 1, further comprising coating the water vapor proof layer at upper and lower chamfers of the liquid crystal curved-surface panel corresponding to the tensile stress area in addition to coating the water vapor proof layer on the tensile stress area and the peripheral area around the tensile stress area.

7. The method according to claim 1, wherein a material of the water vapor proof layer is epoxy resin or metal powders.

8. The method according to claim 1, wherein the tensile stress area of the liquid crystal curved-surface panel subjected to the maximum tensile stress is determined by a computer simulation model.

9. The method according to claim 1, wherein the liquid crystal curved-surface panel comprises an array substrate and a color film substrate facing each other, wherein the array substrate is subjected to a tensile stress, and the color film substrate is subjected to a compressive stress, and the tensile stress area is located on the array substrate.

10. The method according to claim 9, wherein the liquid crystal curved-surface panel is an organic glass panel, and the tensile stress area is located at a curved region having a largest curvature of the array substrate.

11. A method for enhancing a strength of a liquid crystal curved-surface panel, comprising the steps of:
1) determining a tensile stress area where the liquid crystal curved-surface panel undergoes a maximum tensile stress;
2) calculating a length and a width of the tensile stress area;
3) removing microcracks on the tensile stress area so as to coat a water vapor proof layer on the tensile stress area; and
4) coating a water vapor proof layer on the tensile stress area and a peripheral area around the tensile stress area, the water vapor proof layer preventing an invasion of water vapor,
wherein a volume of the water vapor proof layer coated on the peripheral area around the tensile stress area is determined according the length and the width of the tensile stress area.

12. The method according to claim 11, wherein an erosion material able to erode the liquid crystal curved-surface panel is used to remove the microcracks on the tensile stress area.

13. The method according to claim 12, wherein the erosion material is hydrofluoric acid and a volume of the hydrofluoric acid is determined according to a depth of the microcracks.

14. The method according to claim 11, further comprising coating the water vapor proof layer at upper and lower chamfers of the liquid crystal curved-surface panel corresponding to the tensile stress area in addition to coating the water vapor proof layer on the tensile stress area and the peripheral area around the tensile stress area.

15. The method according to claim 11, wherein a material of the water vapor proof layer is epoxy resin or metal powders.

16. The method according to claim 11, wherein the tensile stress area of the liquid crystal curved-surface panel subjected to the maximum tensile stress is determined by a computer simulation model.

17. The method according to claim 11, wherein the liquid crystal curved-surface panel comprises an array substrate and a color film substrate facing each other, wherein the array substrate is subjected to a tensile stress, and the color film substrate is subjected to a compressive stress, and the tensile stress area is located on the array substrate.

18. The method according to claim 17, wherein the liquid crystal curved-surface panel is an organic glass panel, and the tensile stress area is located at a curved region having a largest curvature of the array substrate.
